(19) United States
(12) Patent Application Publication
(10) Pub. No.: US 2025/0133368 A1
(43) Pub. Date: Apr. 24, 2025

(54) METHOD FOR DETERMINING SENSING NODE, AND DEVICE THEREOF

(71) Applicant: GUANGDONG OPPO MOBILE TELECOMMUNICATIONS CORP., LTD., Dongguan (CN)

(72) Inventors: Xinlei YU, Dongguan (CN); Yang LIU, Dongguan (CN); Cong SHI, Dongguan (CN)

(21) Appl. No.: 19/000,911

(22) Filed: Dec. 24, 2024

Related U.S. Application Data
(63) Continuation of application No. PCT/CN2022/102246, filed on Jun. 29, 2022.

(51) Int. Cl. H04W 4/021; H04W 74/0833

(52) U.S. Cl. CPC H04W 4/021; H04W 74/0833

(57) ABSTRACT

Provided is a method for determining a sensing node. The method is applicable to a first device, and includes: receiving a sensing request message from a second device, the sensing request message including information of an AOI, wherein the AOI is an area to be measured in sensing measurement; and transmitting a feedback message to the second device based on position information of the first device and the information of the AOI, wherein the feedback message is for determining the sensing node participating in the sensing measurement.

### CROSS-REFERENCE TO RELATED APPLICATION

This application is a continuation of International Application No. PCT/CN2022/102246, filed on Jun. 29, 2022, the entire disclosure of which is hereby incorporated herein by reference.

### TECHNICAL FIELD

Embodiments of the present disclosure relates to the technical field of sensing, and in particular, relate to a method and apparatus for determining a sensing node, and a device, a system, and a medium thereof.

### BACKGROUND

In environment sensing based on wireless electromagnetic waves used in cellular networks, sensing measurement is categorized into active sensing and passive sensing based on different sensing targets. In active sensing, the sensing target is a terminal device (user equipment, UE), that is, the active sensing is per-UE sensing. In passive sensing, the sensing target is a target area, that is, the passive sensing is per-area sensing.

### SUMMARY

Embodiments of the present disclosure provide a method for determining a sensing node, and a device thereof. The technical solutions are as follows.

According to some embodiments of the present disclosure, a method for determining a sensing node is provided. The method is applicable to a first device, and includes:
receiving a sensing request message from a second device, the sensing request message including information of an area of interest (AOI), wherein the AOI is an area to be measured in sensing measurement; and
transmitting a feedback message to the second device based on position information of the first device and the information of the AOI, wherein:
the feedback message is for determining the sensing node participating in the sensing measurement.

According to some embodiments of the present disclosure, a method for determining a sensing node is provided. The method is applicable to a second device, and includes:

transmitting a sensing request message to a first device, the sensing request message including information of an AOI, wherein the AOI is an area to be measured in sensing measurement;
receiving a feedback message from the first device; and
determining, based on the feedback message, the sensing node participating in the sensing measurement.

According to some embodiments of the present disclosure, a terminal device is provided. The terminal device includes: a processor, a transceiver connected to the processor, and a memory storing one or more executable instructions of the processor; wherein the processor, when loading and executing the one or more executable instructions, is caused to perform the method for determining the sensing node in the above embodiments.

### BRIEF DESCRIPTION OF DRAWINGS

For clearer descriptions of the technical solutions according to the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is an architecture diagram of a 5^{th} generation mobile communication (5G) network according to some embodiments of the present disclosure;

FIG. 2 is a flowchart of per-UE sensing according to some embodiments of the present disclosure;

FIG. 3 is a flowchart of per-area sensing according to some embodiments of the present disclosure;

FIG. 4 is a flowchart of a method for determining a sensing node according to some embodiments of the present disclosure;

FIG. 5 is a flowchart of a method for determining a sensing node according to some embodiments of the present disclosure;

FIG. 6 is a flowchart of a method for determining a sensing node according to some embodiments of the present disclosure;

FIG. 7 is a flowchart of a method for determining a sensing node according to some embodiments of the present disclosure;

FIG. 8 is a flowchart of a method for determining a sensing node according to some embodiments of the present disclosure;

FIG. 9 is a flowchart of a method for determining a sensing node according to some embodiments of the present disclosure;

FIG. 10 is a flowchart of a method for determining a sensing node according to some embodiments of the present disclosure;

FIG. 11 is a flowchart of a method for determining a sensing node according to some embodiments of the present disclosure;

FIG. 12 is a block diagram of an apparatus for determining a sensing node according to some embodiments of the present disclosure;

FIG. 13 is a block diagram of an apparatus for determining a sensing node according to some embodiments of the present disclosure; and

FIG. 14 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are described in detail hereinafter in conjunction with the accompanying drawings.

Embodiments are illustratively described herein and are illustrated in the accompanying drawings. Unless otherwise indicated, the same number in different accompanying drawings indicates the same or similar elements in following descriptions of the accompanying drawings. The following exemplary embodiments do not represent all embodiments consistent with the present disclosure, and are merely examples of devices and methods that are consistent with aspects of the present disclosure as detailed in the appended claims.

The terms used in the present disclosure are for describing specific embodiments and are not intended to limit the present disclosure. The terms “a,” “an” and “the” in the singular form used in the present disclosure and the appended claims are also intended to include the plural form, unless clearly indicates in the context otherwise. It is understandable that the term “and/or” herein indicates and includes any or all possible combinations of one or more associated listed items.

It should be understood that although the terms first, second, third, and the like may be used to describe various types of information in the present disclosure, such information should not be limited to the terms. The terms are used only to distinguish the same type of information. For example, without departing from the scope of the present disclosure, the first information may also be referred to as the second information, and likewise, the second information may also be referred to as the first information. Depending on the context, the term “if” used herein may be interpreted as the term “when,” “in the case that,” or “determining in response to.”

At first, the related technical background of the embodiments of the present disclosure is described.

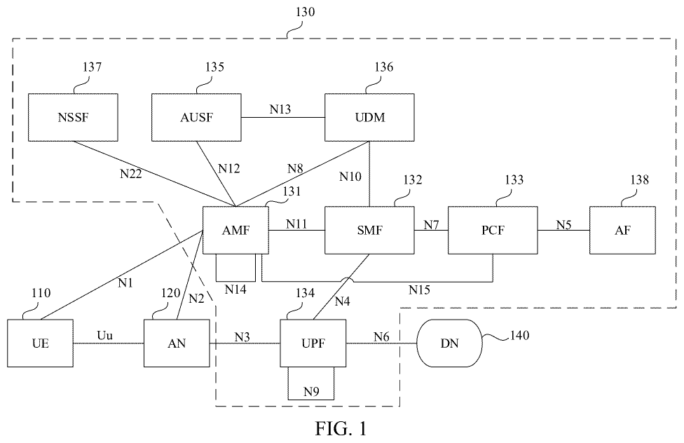

Referring to FIG. 1, an architecture diagram of a 5G network according to some embodiments of the present disclosure is illustrated. The network structure includes a terminal UE 110, an access network 120, and a core network 130.

The terminal 110 includes various handheld devices, in-vehicle devices, wearable devices, computing devices, Internet of things (IoT) devices, industry IoT (IIoT) devices, other processing devices connected to wireless modems, various forms of UEs, mobile stations (MS), terminal devices, and other devices with the wireless communication function. For convenient description, the above devices are collectively referred to as the terminal.

The access network 120 includes several access network devices. Each of the access network devices is a base station, and the base station is a device deployed in the access network and providing a wireless communication function for the terminal. The base station includes various types of macro base stations, micro base stations, relay stations, access points, transmission reception points (TRP), and the like. In systems using different radio access technologies, a device with the base station function may have different names, for example, eNodeB or eNB in a long-term evolution (LTE) system, or gNode B or eNB in a 5G new radio (NR) system. With the evolution of communications technologies, the name “base station” changes. For convenient description, the above devices providing the wireless communication function for the terminal are collectively referred to as the access network device in the embodiments of the present disclosure. The terminal 110 and the access network 120 achieve access stratum connection, access stratum message interaction, and wireless data transmission therebetween over a Uu interface.

The core network 130 includes several core network devices. Each of the core network devices includes an access and mobility management function (AMF) 131, a session management function (SMF) 132, a policy control function (PCF) 133, a user plane function (UPF) 134, an authentication server function (AUSF) 135, unified data management (UDM) 136, a network slice selection function (NSSF) 137, and an application function (AF) 138.

The terminal 110 and the AMF 131 in the core network 130 achieve non-access stratum (NAS) connection and NAS message interaction therebetween over an N1 interface. In addition to performing mobility management on the UE 110, the AMF 131 further forwards messages related to session management between the SMF 132 and the terminal 110. The PCF 133 formulates policies related to mobility management, session management, and billing for the terminal 110. The UPF 134 and an external data network (DN) 140 achieve data transmission therebetween over an N6 interface, the UPF 134 and the AN 120 achieve data transmission therebetween over an N3 interface. The AUSF 135 achieves 3^{rd} generation partnership project (3GPP) and non-3GPP access authentication. The UDM 136 provides functions for 3GPP third-generation communication networks, including authentication and key agreement (AKA) authentication, user identification, access authorization, registration, mobility, subscription, short message service (SMS) management. The NSSF 137 determines, based on slice selection assistance information, subscription information, and the like, network slice instances that the terminal 110 is allowed to access. The AF 138 provides access to network exposure functions, and interacts with the policy framework for policy control and other related tasks.

It is understandable that in some embodiments of the present disclosure, the 5G NR system

is also referred to as a 5G system or NR. The technical solutions according to some embodiments of the present disclosure are applicable to the 5G NR system, evolution systems of the 5G NR system, and also applicable to 6^{th} generation mobile communication (6G) and evolved systems of 6G.

The wireless electromagnetic wave signals used in the cellular network are used for wireless data transmission and communication and have an environment sensing capability, such as user action or gesture recognition, breath monitoring, terminal movement speed measurement, environmental imaging, weather monitoring, and the like. Thus, further cellular networks are not only used for communication and data transmission, but may be extended to the field of acquisition of sensing information.

Currently, the sensing function (SF) is supported in the beyond 5G (B5G) network by adding a sensing control network element and corresponding processes into the 3GPP network. In implementations of the sensing function, the sensing measurement is categorized into active sensing and passive sensing based on different sensing targets. In the active sensing, the sensing target is the UE, that is, the active sensing is per-UE sensing. In the passive sensing, the sensing target is a target area or a target object, that is, the per-area sensing has no specific UE and does not belong to the 3GPP.

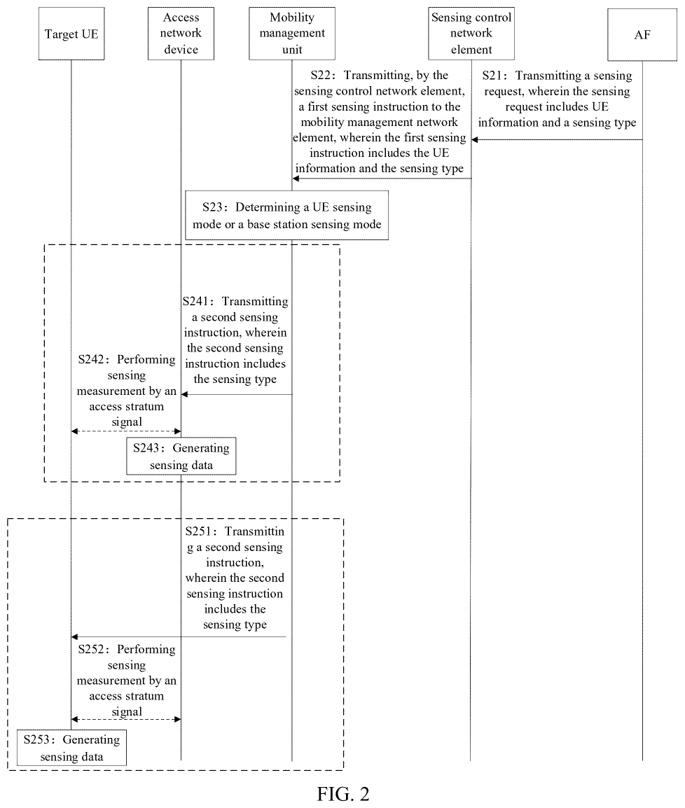

In some embodiments, as shown in FIG. 2, a flowchart of per-UE sensing according to some embodiments of the present disclosure is illustrated. The procedure includes following processes. In S21, an AF transmits a sensing request to a sensing control network element, wherein the sensing request includes UE information and a sensing type. In S22, the sensing control network element transmits a first sensing instruction to a mobility management network element, wherein the first sensing instruction includes UE information and a sensing type. In S23, the mobility management network element determines a UE sensing mode or a base station sensing mode. In S241, the mobility management network element transmits a second sensing instruction to an access network device, wherein the second sensing instruction includes a sensing type. In S242, sensing measurement is performed between the access network device and a target UE by an access stratum signal. In S243, the access network device generates sensing data. In S251, the mobility management network element transmits a second sensing instruction to the target UE, wherein the second sensing instruction includes a sensing type. In S252, the sensing measurement is performed between the target UE and the access network device by an access stratum signal. In S253, the target UE generates sensing data. S241 to S243 are processes corresponding to the base station sensing mode. S251 to S253 are processes corresponding to the UE sensing mode.

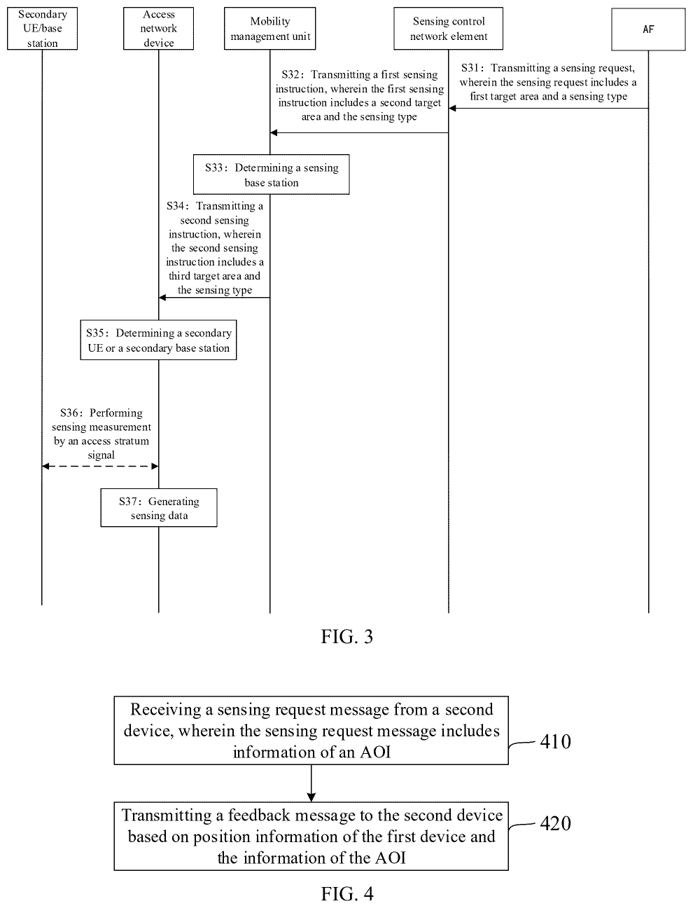

In some embodiments, as shown in FIG. 3, a flowchart of per-area sensing according to some embodiments of the present disclosure is illustrated. The process includes following processes. In S31, an AF transmits a sensing request to a sensing control network element, wherein the sensing request includes a first target area and a sensing type. In S32, the sensing control network element transmits a first sensing instruction to a mobility management network element, wherein the first sensing instruction includes a second target area and a sensing type. In S33, the mobility management network element determines a sensing base station. In S34, the mobility management network element transmits a second sensing instruction to an access network device, wherein the second sensing instruction includes a third target area and a sensing type. In S35, the access network device determines a secondary UE or a secondary base station. In S36, sensing measurement is performed between the access network device and the secondary UE or the secondary base station by an access stratum signal. In S37, the access network device generates sensing data.

In above embodiments, the sensing measurement process is achieved by cooperative sensing between the terminal and the base station. In addition, other communication-sensing-integrated wireless sensing scenarios are also included in the embodiments. Illustratively, the communication-sensing-integrated wireless sensing scenarios include:
1) a base station echo sensing link (single gNB sensing), wherein the base station transmits sensing signals and receives echo signals;
2) a sensing link between base stations (gNB-gNB sensing), wherein the base station B receives sensing signals from the base station A;
3) an air interface sensing uplink (UE-gNB uplink sensing), wherein the base station receives sensing signals from the terminal;
4) an air interface sensing downlink (UE-gNB downlink sensing), wherein the terminal receives sensing signals from the base station;
5) a terminal echo sensing link (single UE sensing), wherein the terminal transmits sensing signals and receives echo signals; and
6) a sensing link between terminals (UE-UE sensing), wherein the terminal B receives sensing signals from the terminal A.

It should be noted that in an initial stage of B5G integrated communication and sensing, sensing behaviors are performed by reusing existing air interface signals as much as possible, without introducing too much air interface enhancement. Given complexity of full-duplex implementations, the cooperative sensing between the terminals and/or the base stations is a priority direction.

### Selection of the Sensing Node

In the case that the sensing target is the per-UE (the active sensing), a target UE is present, and thus the process of selecting the sensing node is simplified. Other UEs or gNBs around the target UE are determined as sensing secondary nodes to jointly perform the sensing. That is, the target UE acts as the sensing node, and other UEs or gNBs act as the sensing secondary nodes. Both the sensing node and the sensing secondary nodes are sensing participate nodes in the sensing measurement. For UE-UE sensing, that is, determining other UEs around the target UE as secondary sensing nodes, available candidate sensing nodes (UE) around the UE are determined by sidelink (SL) discovery or R18 SL positioning. For UE-gNB sensing, that is, determining gNBs around the target UE as sensing secondary nodes, the SF or the AMF knows accurate positions of the service gNB of the target UE and the gNB of the neighboring area, and selects appropriate sensing nodes (gNB) from the service gNB of the target UE and the gNB of the neighboring area using the existing neighboring area measurement report mechanism, for example, based on a measurement results of a reference signal received power (RSRP) or a reference signal received quality (RSRQ).

In the case that the sensing target is the per-area (the passive sensing), appropriate gNBs or UEs are determined for the target area as sensing nodes or sensing secondary nodes. For a sensing scenario where only the gNB participates in, for example, echo sensing of a base station and sensing between base stations, gNBs around the target area are determined as sensing nodes in the process of selecting the sensing node. As the SF or the AMF knows positions of all gNBs, the SF or the AMF directly selects the appropriate gNBs in or around the target area as sensing nodes or sensing secondary nodes without additional assistance information. For a sensing scenario where the UE participates in, for example, the air interface uplink sensing, the air interface downlink sensing, the terminal echo sensing, the sensing between terminals, UEs around the target area are determined as sensing nodes or sensing secondary nodes in the process of selecting the sensing node. However, the gNB, the SF and the AMF cannot accurately know distribution of UEs in or around the target area, and thus UE report assistance information or other mechanisms are required. For the target area, the SF or the AMF of the core network selects appropriate gNBs, and the SF, the AMF, or the gNB selects secondary UEs.

For a sensing scenario where the UE participates in and the sensing target is per-area, the SF/AMF/gNB of the core network selects appropriate secondary UEs around the target area as the sensing nodes to participate in the sensing measurement. As the AMF, the SF, and the gNB cannot accurately know distribution of UEs in or around the target area, it is difficult to determine appropriate secondary UEs as sensing nodes for the target area in the process of performing sensing measurement on the target area.

In view of the above problem, embodiments of the present disclosure provide a method for determining a sensing node and a solution for determining a sensing node. Referring to FIG. 4, a flowchart of a method for determining a sensing node according to some embodiments of the present disclosure is illustrated. The embodiments are illustrated using the method being applicable to the first device as an example. The first device is a terminal device or an access network device. The method includes following processes.

In S410, a sensing request message is received from a second device, wherein the sensing request message includes information of an AOI.

The AOI is an area to be measured in sensing measurement. That is, the information of the AOI describes a geographic area, the area is an area required for the sensing measurement, and the second device expects to search for potential sensing nodes for the AOI. The sensing measurement refers to sensing measurement in the cellular network.

In some embodiments, the geographic area indicated by the AOI may be an area defined at the granularity of a cell, a gNB, or a tracking area (TA), or an area defined by a granularity smaller than any of the granularity of a cell, a gNB, or a TA.

In some embodiments, in the case that the granularity is smaller than the granularity of a cell, the second device cannot know position information of the first device, and thus the AOI needs to be indicated to the first device by the sensing request message in the sensing measurement, such that the first device gives feedback based on the position information of the first device and the AOI to assist the second device in determining the sensing node.

In some embodiments, the information of the AOI includes at least one of: coordinates of reference points of the AOI and a radius of the AOI; coordinates of reference points of the AOI, a length of the AOI, and a width of the AOI; or at least one zone identifier (zone ID), indicating a geographic zone. In some embodiments, the zone ID is preconfigured by the second device, or is determined based on the formula in section 5.10.13.2 of the 36.331 protocol in the 3GPP standard.

In some embodiments, the sensing request message is carried in at least one of a broadcast message, a paging message, radio resource control (RRC) signaling, medium access control (MAC) control element (CE) signaling, or an NAS message.

Illustratively, the second device is a device for configuring the sensing node participating in the sensing measurement. In some embodiments, the second device is at least one of a terminal device, an access network device, or a core network device.

In S420, a feedback message is transmitted to the second device based on position information of the first device and the information of the AOI.

The feedback message is for determining the sensing node participating in the sensing measurement. In some embodiments, the sensing nodes is at least one of a sensing master node or a sensing secondary node.

In some embodiments, the first device acquires position information of its geographic position in response to receiving the sensing request message.

In some embodiments, the position information of the first device is acquired by a global navigation satellite system (GNSS) or mobile communication positioning. In some embodiments, in the case that the position information of the first device is acquired by the mobile communication positioning, the mobile communication positioning is an NR positioning technology achieved by triggering signaling interaction between the base station and the terminal, or an SL positioning technology achieved by SL communication between the terminals, or other positioning technologies, which is not limited herein.

In some embodiments, measurement of the position information of the first device by the first device is triggered by receipt of the sensing request message. That is, in response to receiving the sensing request message, the first device measures the position of the first device by the GNSS function or the mobile communication positioning to acquire the position information. Alternatively, the first device automatically measures the position information of the first device based on a specific period. Upon receipt of the sensing request message, the position information acquired in latest measurement or the latest valid position information is used.

In some embodiments, the first device performs validity detection on acquired position information. In the case that the position information of the first device is valid information, the first device transmits the feedback message to the second device based on the position information of the first device and the information of the AOI. In some embodiments, in the case that non-real-time measured position information acquired by the first device is valid information, the position information is directly used in the process of transmitting the feedback message based on the position information and the AOI. That is, the measurement of the position information does not need to be triggered in real time.

In some embodiments, the feedback message from the first device to the second device is for indicating a matching result of the position information of the first device and the AOI. That is, the first device feeds back the matching result of the position information and the AOI to the second device, and the second device determines, based on the feedback message, whether the first device is in the AOI, and selects a device from first devices in the AOI as the sensing node. Alternatively, the feedback message from the first device to the second device is for indicating whether the first device is capable of participating in the sensing measurement. That is, in the case that the first device is in the AOI, the first device transmits the feedback message indicating capable of participating in the sensing measurement to the second device; and in the case that the first device is not in the AOI, the first device transmits the feedback message indicating not participating in the sensing measurement to the second device, and the second device selects a device from first devices as the sensing node based on whether the first device is capable of participating in the sensing measurement.

Illustratively, the first device transmits the feedback message to the second device based on the matching between the position information and the AOI. In some embodiments, the first device transmits different feedback messages to the second device based on different matching situations between the position information and the AOI. In the case that the position information of the first device belongs to the AOI, the first device transmits a first feedback message to the second device, wherein the first feedback message is for indicating that the first device participates in the sensing measurement. In the case that the position information of the first device does not belong to the AOI, the first device transmits a second feedback message to the second device, wherein the second feedback message is for indicating that the first device does not participate in the sensing measurement. That is, in response to receiving the feedback message from the first device, the second device determines that the first device participates in the sensing measurement in the case that the feedback message is the first feedback message, and the second device determines that the first device does not participate in the sensing measurement in the case that the feedback message is the second feedback message.

In some embodiments, the first device transmits the first feedback message to the second device only in the case that the position information is matched with the AOI. In the case that the position information of the first device belongs to the AOI, the first device transmits the feedback message to the second device. In the case that the position information of the first device does not belong to the AOI, the procedure is terminated. In the case that the second device receives the feedback message from the first device, the first device expects to participate in the sensing measurement. In the case that the second device does not receive the feedback message from the first device, the first device does not participate in the sensing measurement.

In some embodiments, the first device transmits the feedback message based on the matching of the position information of the first device and the AOI, and also based on whether the first device expects to participate in the sensing measurement.

In some embodiments, in the case that the position information of the first device belongs to the AOI, and configuration information of the first device is for indicating that the first device does not participate in the sensing measurement, the first device transmits the second feedback message to the second device. That is, in the case that the position of the first device is in the AOI, and the first device does not expect to be the sensing node, the first device transmits the second feedback message to the second device.

In some embodiments, in response to receiving the sensing request message, the first device first determines, based on the configuration information of the first device, whether the first device expects to participate in the sensing measurement. In the case that the configuration information of the first device is for indicating that the first device does not participate in the sensing measurement, the first device directly transmits the second feedback message to the second device, or, the first device does not transmit the feedback message to indicate that the first device does not participate in the sensing measurement. In the case that the configuration information of the first device is for indicating that the first device expects to participate in the sensing measurement, the feedback message is transmitted based on the position information of the first device and the AOI information in the sensing request message.

In some embodiments, the feedback message is carried in at least one of RRC signaling, MAC CE signaling, or an NAS message.

In some embodiments, the first device reports other measurement results to the second device in reporting the feedback message. That is, the first device reports measurement results to the second device, and the measurement results include at least one of an RSRP measurement result, a light-of-sight (LOS) probability, or a non-light-of-sight (LOS) probability.

In summary, in the method according to the embodiments, based on the information of the AOI and the position information of the first device, the second device is assisted in determining the sensing nodes participating in the sensing measurement, and the solution for determining the sensing nodes is provided in the case that device distribution is unknown, such that the accuracy of determining the sensing node is improved.

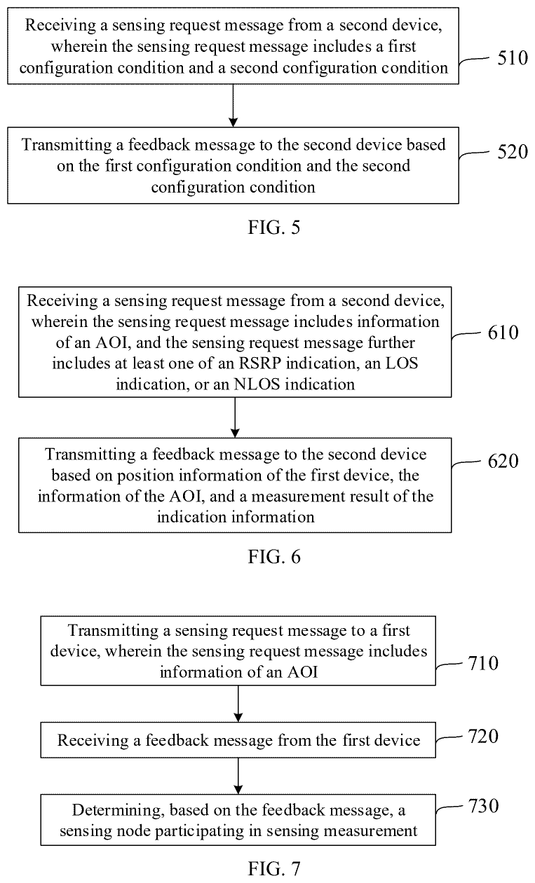

In some embodiments, the information of the AOI is a first configuration condition in the sensing request message, and the sensing request message further includes a second configuration condition. That is, the first device transmits the feedback message to the second device based on the first configuration condition and the second configuration condition. Referring to FIG. 5, a flowchart of a method for determining a sensing node according to some embodiments of the present disclosure is illustrated. The embodiments are illustrated using the method being applicable to the first device as an example. The first device is a terminal device or an access network device. The method includes following processes.

In S510, a sensing request message is received from a second device, wherein the sensing request message includes a first configuration condition and a second configuration condition.

The first configuration condition is the information of the AOI, and the AOI is an area to be measured in sensing measurement. That is, the information of the AOI describes a geographic area, the area is an area required for the sensing measurement, and the second device expects to search for potential sensing nodes for the AOI.

In some embodiments, the geographic area indicated by the AOI may be an area defined at the granularity of a cell, a gNB, or a TA, or an area defined by a granularity smaller than any of the granularity of a cell, a gNB, or a TA.

In some embodiments, the information of the AOI includes at least one of: coordinates of reference points of the AOI and a radius of the AOI; coordinates of reference points of the AOI, a length of the AOI, and a width of the AOI; or at least one zone ID, indicating a geographic zone. In some embodiments, the zone ID is preconfigured by the second device, or is determined based on the formula in section 5.10.13.2 of the 36.331 protocol in the 3GPP standard.

In some embodiments, the second configuration condition includes at least one of an RSRP threshold, an LOS probability threshold, or an NLOS probability threshold. The RSRP indication is for instructing the first device to measure the RSRP and report the feedback message based on the RSRP measurement result, the LOS indication is for instructing the first device to measure the LOS probability and report the feedback message based on the measured LOS probability, and the NLOS indication is for instructing the first device to measure the NLOS probability and report the feedback message based on the measured NLOS probability.

In some embodiments, the sensing request message is carried in at least one of a broadcast message, a paging message, RRC signaling, MAC CE signaling, or an NAS message.

Illustratively, the second device is a device for configuring the sensing node participating in the sensing measurement. In some embodiments, the second device is at least one of a terminal device, an access network device, or a core network device.

In S520, a feedback message is transmitted to the second device based on the first configuration condition and the second configuration condition.

In some embodiments, the feedback message includes condition matching results corresponding to various configuration conditions indicated by the sensing request message. That is, the condition matching results corresponding to the first configuration condition and the second configuration condition are reported to the second device over the feedback message. In some embodiments, the first device reports condition matching results corresponding to a plurality of configuration conditions over a same feedback message. For example, the feedback message includes a first condition matching result corresponding to the first configuration condition and a second condition matching result corresponding to the second configuration condition. Alternatively, the first device reports condition matching results corresponding to different configuration conditions over a plurality of feedback messages. That is, the first device transmits N feedback messages to the second device. An i^{th} feedback message is for indicating a condition matching result corresponding to an i^{th} configuration condition. N and i are positive integers.

In some embodiments, the feedback message includes a total condition matching result corresponding to all configuration conditions indicated by the sensing request message. The total condition matching result is for indicating condition matching results corresponding to all configuration conditions. Illustratively, in determination of the total condition matching result based on the condition matching results corresponding to configuration conditions, the first device transmits, in response to successful matching of at least one of the plurality of configuration conditions, the feedback message indicating that the first device is determined as the sensing node; and the first device transmits, in response to successful matching of all of the plurality of configuration conditions, the feedback message indicating that the first device is capable of acting as the sensing node.

In some embodiments, the first device transmits different feedback messages to the second device based on condition matching results corresponding to the plurality of configuration conditions. That is, the first device determines, based on the configuration conditions, whether the first device is capable of acting as the sensing node. In the case that the first device is determined to be capable of acting as the sensing node, the first device transmits the first feedback message to the second device. In the case that the first device is determined to be incapable of acting as the sensing node, the first device transmits the second feedback message to the second device.

In some embodiments, the first device determines, based on the condition matching results corresponding to the plurality of configuration conditions, whether to transmit the feedback message to the second device. That is, the first device determines, based on the configuration conditions, whether the first device is capable of acting as the sensing node. In the case that the first device is determined to be capable of acting as the sensing node, the first device transmits the first feedback message to the second device. In the case that the first device is determined to be incapable of acting as the sensing node, the procedure is terminated.

In some embodiments, in the case that the first device meets at least one of the plurality of configuration conditions, the first device is determined as the sensing node. Alternatively, in the case that the first device meets all of the plurality of configuration conditions, the first device is determined to be capable of acting as the sensing node.

In some embodiments, the feedback message is carried in at least one of RRC signaling, MAC CE signaling, or an NAS message.

In summary, in the method according to the embodiments, the first device determined, based on the configuration conditions indicated by the second device based on the sensing request message, whether the first device is determined as the sensing node, the solution for determining the sensing nodes is provided in the case that device distribution is unknown, and determination of the sensing node is further assisted by the RSRP, the LOS probability, or the NLOS probability, such that the accuracy of determining the sensing node is improved.

In some embodiments, the sensing request message further includes at least one of an RSRP indication, an LOS indication, or an NLOS indication, and the indication information is for instructing the first device to report measurement results corresponding to the indication information. Referring to FIG. 6, a flowchart of a method for determining a sensing node according to some embodiments of the present disclosure is illustrated. The embodiments are illustrated using the method being applicable to the first device as an example. The first device is a terminal device or an access network device. The method includes following processes.

In S610, a sensing request message is received from a second device, wherein the sensing request message includes information of an AOI, and the sensing request message further includes at least one of an RSRP indication, an LOS indication, or an NLOS indication.

The AOI is an area to be measured in sensing measurement. That is, the information of the AOI describes a geographic area, the area is an area required for the sensing measurement, and the second device expects to search for potential sensing nodes for the AOI.

In some embodiments, the geographic area indicated by the AOI may be an area defined at the granularity of a cell, a gNB, or a TA, or an area defined by a granularity smaller than any of the granularity of a cell, a gNB, or a TA.

In some embodiments, the information of the AOI includes at least one of: coordinates of reference points of the AOI and a radius of the AOI; coordinates of reference points of the AOI, a length of the AOI, and a width of the AOI; or at least one zone ID, indicating a geographic zone. In some embodiments, the zone ID is preconfigured by the second device, or is determined based on the formula in section 5.10.13.2 of the 36.331 protocol in the 3GPP standard.

Illustratively, the RSRP indication is for instructing the first device to report the RSRP measurement result, the LOS indication is for instructing the first device to report the LOS probability, and the NLOS indication is for instructing the first device to report the NLOS probability.

In some embodiments, the RSRP measurement result, the LOS probability, and the N LOS probability are measured in real time upon receipt of the sensing request message by the first device. Alternatively, the RSRP measurement result, the LOS probability, and the NLOS probability are premeasured and stored by the first device, and the first device performs subsequent operations based on the prestored information in response to determining that the prestored RSRP measurement result, the LOS probability, and the NLOS probability are valid information.

In some embodiments, the sensing request message is carried in at least one of a broadcast message, a paging message, RRC signaling, MAC CE signaling, or an NAS message.

Illustratively, the second device is a device for configuring the sensing node participating in the sensing measurement. In some embodiments, the second device is at least one of a terminal device, an access network device, or a core network device.

In S620, a feedback message is transmitted to the second device based on position information of the first device, the information of the AOI, and the measurement result of the indication information.

Illustratively, the measurement result is carried in the feedback message. That is, the RSRP measurement result, the LOS probability, and the NLOS probability are reported to the second device over the feedback message.

In some embodiments, in response to determining that the position information of the first device belongs to the AOI, the first device transmits the first feedback message to the second device. The first feedback message is for indicating that the position information of the first device belongs to the AOI, and the first feedback message carries at least one of the RSRP measurement result, the LOS probability, and the NLOS probability. In response to determining that the position information of the first device does not belong to the AOI, the first device transmits the second feedback message to the second device. The second feedback message is for indicating that the position information of the first device does not belong to the AOI.

In some embodiments, in response to determining that the position information of the first device belongs to the AOI, the first device transmits the first feedback message to the second device. The first feedback message is for indicating that the position information of the first device belongs to the AOI, and the first feedback message carries at least one of the RSRP measurement result, the LOS probability, and the NLOS probability. In the case that the first device determines that the position information of the first device does not belong to the AOI, the procedure is terminated.

In some embodiments, the feedback message is carried in at least one of RRC signaling, MAC CE signaling, or an NAS message.

In summary, in the method according to the embodiments, based on the information of the AOI and the position information of the first device, the second device is assisted in determining the sensing nodes participating in the sensing measurement. Meanwhile, in the process of reporting the feedback message, the measurement results of the RSRP, the LOS, and the NLOS are reported over the feedback message, and the solution for determining the sensing nodes is provided in the case that device distribution is unknown, such that information, such as the RSRP, the LOS, and the NLOS, is considered in the process of selecting the sensing node from first nodes in the AOI by the second device, and thus the accuracy of determining the sensing node is improved.

Referring to FIG. 7, a flowchart of a method for determining a sensing node according to some embodiments of the present disclosure is illustrated. The embodiments are illustrated using the method being applicable to the second device as an example. The second device is at least one of a terminal device, an access network device, or a core network device. The method includes following processes.

In S710, a sensing request message is transmitted to a first device, wherein the sensing request message includes information of an AOI.

The AOI is an area to be measured in sensing measurement. That is, the information of the AOI describes a geographic area, the area is an area required for the sensing measurement, and the second device expects to search for potential sensing nodes for the AOI.

In some embodiments, the geographic area indicated by the AOI may be an area defined at the granularity of a cell, a gNB, or a TA, or an area defined by a granularity smaller than any of the granularity of a cell, a gNB, or a TA.

In some embodiments, in the case that the granularity is smaller than the granularity of a cell, the second device cannot know position information of the first device, and thus the AOI needs to be indicated to the first device by the sensing request message in the sensing measurement, such that the first device gives feedback based on position information of the first device and the AOI to assist the second device in determining the sensing node.

In some embodiments, the information of the AOI includes at least one of: coordinates of reference points of the AOI and a radius of the AOI; coordinates of reference points of the AOI, a length of the AOI, and a width of the AOI; or at least one zone ID, indicating a geographic zone.

In some embodiments, the zone ID is preconfigured by the second device, or is determined based on the formula in section 5.10.13.2 of the 36.331 protocol in the 3GPP standard.

In some embodiments, the sensing request message is carried in at least one of a broadcast message, a paging message, RRC signaling, MAC CE signaling, or an NAS message.

Illustratively, the first device is a candidate device participating in the process of determining the sensing node. In some embodiments, the first device is a terminal device or an access network device.

In some embodiments, the second device transmits the sensing request message to at least two first devices. That is, to determine the sensing node, the second device transmits the sensing request message to a plurality of first devices. In some embodiments, the plurality of first devices are first devices of a same type, for example, a plurality of terminal devices. In some embodiments, the plurality of first devices are first devices of different types. For example, the plurality of first devices include at least one terminal device and at least one access network device.

In S720, a feedback message is received from the first device.

In some embodiments, the feedback message is carried in at least one of RRC signaling, MAC CE signaling, or an NAS message.

Illustratively, the feedback message is transmitted by the first device to the second device based on the position information of the first device and the AOI.

In some embodiments, the position information of the first device is acquired by a GNSS or mobile communication positioning. In some embodiments, in the case that the position information of the first device is acquired by the mobile communication positioning, the mobile communication positioning is an NR positioning technology achieved by triggering signaling interaction between the base station and the terminal, or an SL positioning technology achieved by SL communication between the terminals, or other positioning technologies, which is not limited herein.

In some embodiments, the feedback message is transmitted by the first device in the case that the position information of the first device is valid information.

In S730, the sensing node participating in the sensing measurement is determined based on the feedback message.

Illustratively, the second device selects the first device as the sensing node based on the feedback message. In some embodiments, in response to receiving feedback messages from the plurality of first devices, the second device determines at least one of the plurality of first devices as the sensing node for the sensing measurement.

In some embodiments, the sensing nodes include a sensing master node or a sensing secondary node. In some embodiments, the second device determines the first device as the sensing master node based on the feedback message. Alternatively, the second device determines the first device as the sensing secondary node based on the feedback message.

In some embodiments, the second device receives different feedback messages based on whether the first device participates in the sensing measurement. Illustratively, the second device receives the first feedback message from the first device, the first feedback message is for indicating that the first device participates in the sensing measurement, and the second device determines, based on the first feedback message, the first device as the sensing node participating in the sensing measurement; and, the second device receives the second feedback message from the first device, the second feedback message is for indicating that the first device does not participate in the sensing measurement, and the second device determines, based on the second feedback message, that the first device does not participate in the sensing measurement.

In some embodiments, the second device receives the feedback message from the first device only in the case that the first device expects to participate in the sensing measurement. Illustratively, the second device receives the first feedback message from the first device, and determines that the first device participates in the sensing measurement; and the second device does not receive the first feedback message from the first device, and determines that the first device does not participate in the sensing measurement. In some embodiments, the second device determines whether to receive the first feedback message from the first device within a specific duration.

In some embodiments, the feedback message is for indicating whether the position information of the first device belongs to the AOI, and the second device determines, based on whether the position information of the first device belongs to the AOI, whether the first device is determined as the sensing node. In some embodiments, the second device receives different feedback messages based on different matching situations between the position information of the first device and the AOI. The second device receives the first feedback message from the first device, and the first feedback message is for indicating that the position information of the first device belongs to the AOI. The second device receives the second feedback message from the first device, and the second feedback message is for indicating that the position information of the first device does not belong to the AOI. In response to receiving the first feedback message, the second device determines that the position information of the first device belongs to the AOI, and determines the first device as the sensing node. In response to receiving the second feedback message, the second device determines that the position information of the first device does not belong to the AOI, and does not determine the first device as the sensing node.

In some embodiments, the second device receives the feedback message only in the case that the position information of the first device belongs to the AOI. That is, in response to receiving the first feedback message from the first device, the second device determines that the position information of the first device belongs to the AOI, and determines the first device as the sensing node; and in response to not receiving the first feedback message from the first device, the second device determines that the position information of the first device does not belong to the AOI, and does not determine the first device as the sensing node.

In some embodiments, the first device transmits the feedback message based on the matching of the position information of the first device and the AOI, and also based on whether the first device expects to participate in the sensing measurement.

In some embodiments, the second device receives the second feedback message from the first device, and the second feedback message is for indicating that the position information of the first device belongs to the AOI and configuration information of the first device is for indicating that the first device does not participate in the sensing measurement.

In some embodiments, the feedback message is carried in at least one of RRC signaling, MAC CE signaling, or an NAS message.

In summary, in the method according to the embodiments, based on the information of the AOI and the position information of the first device, the second device is assisted in determining the sensing nodes participating in the sensing measurement, and the solution for determining the sensing nodes is provided in the case that device distribution is unknown, such that the accuracy of determining the sensing node is improved.

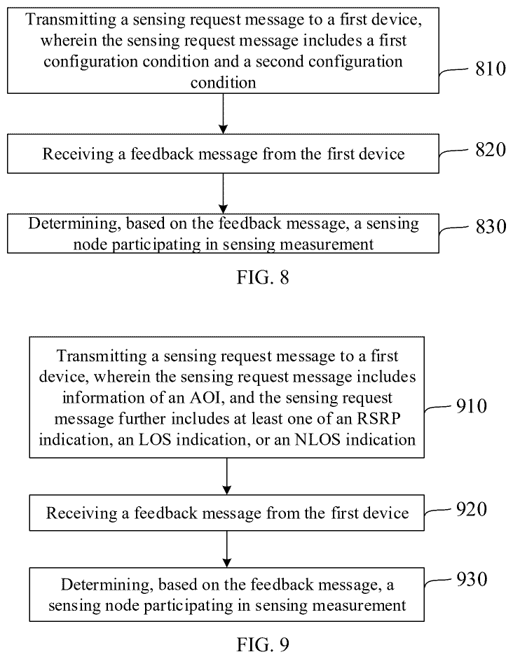

In some embodiments, the sensing request message from the second device to the first device includes a first configuration condition and a second configuration condition. That is, the second device instructs, in response to the sensing request message, the first device to transmit the feedback message to the second device based on the first configuration condition and the second configuration condition. Referring to FIG. 8, a flowchart of a method for determining a sensing node according to some embodiments of the present disclosure is illustrated. The embodiments are illustrated using the method being applicable to the second device as an example. The second device is at least one of a terminal device, an access network device, or a core network device. The method includes following processes.

In S810, a sensing request message is transmitted to a first device, wherein the sensing request message includes a first configuration condition and a second configuration condition.

The first configuration condition is the information of the AOI, and the AOI is an area to be measured in sensing measurement. That is, the information of the AOI describes a geographic area, the area is an area required for the sensing measurement, and the second device expects to search for potential sensing nodes for the AOI.

In some embodiments, the geographic area indicated by the AOI may be an area defined at the granularity of a cell, a gNB, or a TA, or an area defined by a granularity smaller than any of the granularity of a cell, a gNB, or a TA.

In some embodiments, the information of the AOI includes at least one of: coordinates of reference points of the AOI and a radius of the AOI; coordinates of reference points of the AOI, a length of the AOI, and a width of the AOI; or at least one zone ID, indicating a geographic zone. In some embodiments, the zone ID is preconfigured by the second device, or is determined based on the formula in section 5.10.13.2 of the 36.331 protocol in the 3GPP standard.

In some embodiments, the second configuration condition includes at least one of an RSRP threshold, an LOS probability threshold, or an NLOS probability threshold. The RSRP indication is for instructing the first device to measure the RSRP and report the feedback message based on the RSRP measurement result, the LOS indication is for instructing the first device to measure the LOS probability and report the feedback message based on the measured LOS probability, and the NLOS indication is for instructing the first device to measure the NLOS probability and report the feedback message based on the measured NLOS probability.

In some embodiments, the sensing request message is carried in at least one of a broadcast message, a paging message, RRC signaling, MAC CE signaling, or an NAS message.

Illustratively, the second device is a device for configuring the sensing node participating in the sensing measurement. In some embodiments, the second device is at least one of a terminal device, an access network device, or a core network device.

Illustratively, the first device is a candidate device participating in the process of determining the sensing node. In some embodiments, the first device is a terminal device or an access network device.

In some embodiments, the second device transmits the sensing request message to at least two first devices. That is, to determine the sensing node, the second device transmits the sensing request message to a plurality of first devices. In some embodiments, the plurality of first devices are first devices of a same type, for example, a plurality of terminal devices. In some embodiments, the plurality of first devices are first devices of different types. For example, the plurality of first devices include at least one terminal device and at least one access network device.

In S820, a feedback message is received from the first device.

Illustratively, the feedback message is transmitted by the first device based on the first configuration condition and the second configuration condition. The feedback message includes condition matching results corresponding to various configuration conditions indicated by the sensing request message, or, the feedback message includes a total condition matching result corresponding to all configuration conditions indicated by the sensing request message.

In some embodiments, a same feedback message corresponds to condition matching results corresponding to a plurality of configuration conditions. For example, the feedback message includes a first condition matching result corresponding to the first configuration condition and a second condition matching result corresponding to the second configuration condition.

Alternatively, the second device receives a plurality of feedback messages from a same first device. An i^{th} feedback message is for indicating a condition matching result corresponding to an i^{th} configuration condition. N and i are positive integers.

In some embodiments, the feedback message is carried in at least one of RRC signaling, MAC CE signaling, or an NAS message.

In S830, the sensing node participating in the sensing measurement is determined based on the feedback message.

Illustratively, the second device selects the first device as the sensing node based on the feedback message. In some embodiments, in response to receiving feedback messages from a plurality of first devices, the second device determines at least one of the plurality of first devices as the sensing node for the sensing measurement.

Illustratively, the second device determines the first device as the sensing node in the case that the feedback message is for indicating that the position information of the first device belongs to the AOI, and the first device meets the second configuration condition.

In some embodiments, in the case that the sensing request message is for indicating a plurality of second configuration conditions, the first device is determined as the sensing node in the case that the first device meets at least one of the plurality of second configuration conditions, or, the first device is determined as the sensing node in the case that the first device meets all of the plurality of second configuration conditions.

In some embodiments, in the case that a plurality of first devices are in the AOI, the second device selects at least one device from the plurality of first devices as the sensing node based on condition meeting cases of first devices for the second configuration condition in the feedback message. For example, the second device selects a device from the plurality of first devices of which the RSRP measurement result meets an RSRP threshold, and/or, the LOS probability meets an LOS probability threshold, and/or, and the NLOS probability meets an NLOS probability threshold and determines the device as the sensing node.

In summary, in the method according to the embodiments, the first device determined, based on the configuration conditions indicated by the second device based on the sensing request message, whether the first device is determined as the sensing node, the solution for determining the sensing nodes is provided in the case that device distribution is unknown, and determination of the sensing node is further assisted by the RSRP, the LOS probability, or the NLOS probability, such that the accuracy of determining the sensing node is improved.

In some embodiments, the sensing request message from the second device to the first device further includes at least one of an RSRP indication, an LOS indication, or an NLOS indication, and the indication information is for instructing the first device to report measurement results corresponding to the indication information. Referring to FIG. 9, a flowchart of a method for determining a sensing node according to some embodiments of the present disclosure is illustrated. The embodiments are illustrated using the method being applicable to the second device as an example. The second device is at least one of a terminal device, an access network device, or a core network device. The method includes following processes.

In S910, a sensing request message is transmitted to a first device, wherein the sensing request message includes information of an AOI, and the sensing request message further includes at least one of an RSRP indication, an LOS indication, or an NLOS indication.

The AOI is an area to be measured in sensing measurement. That is, the information of the AOI describes a geographic area, the area is an area required for the sensing measurement, and the second device expects to search for potential sensing nodes for the AOI.

In some embodiments, the geographic area indicated by the AOI may be an area defined at the granularity of a cell, a gNB, or a TA, or an area defined by a granularity smaller than any of the granularity of a cell, a gNB, or a TA.

In some embodiments, the information of the AOI includes at least one of: coordinates of reference points of the AOI and a radius of the AOI; coordinates of reference points of the AOI, a length of the AOI, and a width of the AOI; or at least one zone ID, indicating a geographic zone. In some embodiments, the zone ID is preconfigured by the second device, or is determined based on the formula in section 5.10.13.2 of the 36.331 protocol in the 3GPP standard.

Illustratively, the RSRP indication is for instructing the first device to report the RSRP measurement result, the LOS indication is for instructing the first device to report the LOS probability, and the NLOS indication is for instructing the first device to report the NLOS probability.

In some embodiments, the sensing request message is carried in at least one of a broadcast message, a paging message, RRC signaling, MAC CE signaling, or an NAS message.

In S920, a feedback message is received the first device.

Illustratively, the feedback message is transmitted by the first device to the second device based on the position information of the first device, information of the AOI, and the measurement result of the indication information. The measurement result is carried in the feedback message. That is, the RSRP measurement result, the LOS probability, and the NLOS probability are reported to the second device over the feedback message.

In some embodiments, the second device receives the first feedback message from the first device. The first feedback message is for indicating that the position information of the first device belongs to the AOI, and the first feedback message carries at least one of the RSRP measurement result, the LOS probability, and the NLOS probability. Alternatively, the second device receives the second feedback message from the first device. The second feedback message is for indicating that the position information of the first device does not belong to the AOI, or, the position information of the first device belongs to the AOI and configuration information of the first device is for indicating that the first device does not participate in the sensing measurement.

In some embodiments, the second device receives the first feedback message from the first device. The first feedback message is for indicating that the position information of the first device belongs to the AOI, and the first feedback message carries at least one of the RSRP measurement result, the LOS probability, and the NLOS probability. Alternatively, the second device does not receive the feedback message from the first device, and the second device determines that the position information of the first device does not belong to the AOI, or, the position information of the first device belongs to the AOI and configuration information of the first device is for indicating that the first device does not participate in the sensing measurement.

In some embodiments, the feedback message is carried in at least one of RRC signaling, MAC CE signaling, or an NAS message.

In S930, the sensing node participating in the sensing measurement is determined based on the feedback message.

Illustratively, the second device selects the first device as the sensing node based on the feedback message. In some embodiments, in response to receiving feedback messages from the plurality of first devices, the second device determines at least one of the plurality of first devices as the sensing node for sensing measurement.

In some embodiments, in response to determining that position information of a plurality of first devices belongs to the AOI, the second device determines at least one device from the plurality of first devices as the sensing node based on measurement results in the feedback message. For example, the second device selects a device from the plurality of first devices of which the RSRP measurement result meets an RSRP threshold, and/or, the LOS probability meets an LOS probability threshold, and/or, and the NLOS probability meets an NLOS probability threshold and determines the device as the sensing node. The RSRP threshold, the LOS probability threshold, and the NLOS probability threshold are defined for the second device to screen out the first device.

In summary, in the method according to the embodiments, based on the information of the AOI and the position information of the first device, the second device is assisted in determining the sensing nodes participating in the sensing measurement. Meanwhile, in the process of reporting the feedback message, the measurement results of the RSRP, the LOS, and the NLOS are reported over the feedback message, and the solution for determining the sensing nodes is provided in the case that device distribution is unknown, such that information, such as the RSRP, the LOS, and the NLOS, is considered in the process of selecting the sensing node from first nodes in the AOI by the second device, and thus the accuracy of determining the sensing node is improved.

Illustratively, following embodiments are illustrated in detail using the method for determining the sensing node according to the embodiments of the present disclosure being applicable to a sensing scenario that the UE participates in and the sensing target is per-area as an example.

For the passive sensing of the AOI, the network device selects the sensing node.

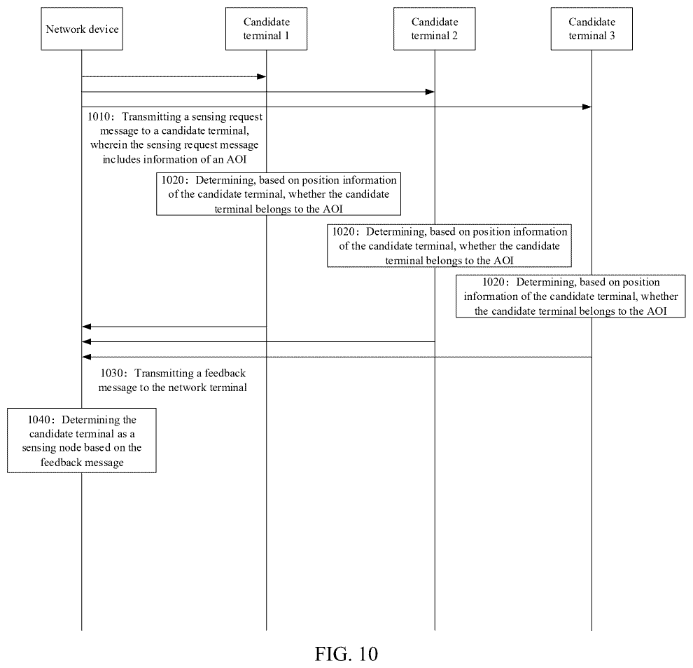

Referring to FIG. 10, a flowchart of a method for determining a sensing node according to some embodiments of the present disclosure is illustrated. In the embodiments, the first device is at least one candidate terminal, the second device is a network device, and the procedure of configuring the sensing node by the network device for the sensing measurement of the AOI in the passive sensing is illustrated. The method includes following processes.

In S1010, a network device transmits a sensing request message to a candidate terminal, wherein the sensing request message includes information of an AOI.

The AOI is an area to be measured in sensing measurement. That is, the information of the AOI describes a geographic area, the area is an area required for the sensing measurement, and the network device expects to search for potential sensing nodes for the AOI.

In some embodiments, the geographic area indicated by the AOI may be an area defined at the granularity of a cell, a gNB, or a TA, or an area defined by a granularity smaller than any of the granularity of a cell, a gNB, or a TA.

In some embodiments, in the case that the granularity is smaller than the granularity of a cell, the network device cannot know position information of the candidate terminal, and thus the AOI needs to be indicated to the candidate terminal by the sensing request message in the sensing measurement, such that the candidate terminal gives feedback based on position information of the candidate terminal and the AOI to assist the network device in determining the sensing node.

In some embodiments, the information of the AOI includes at least one of: coordinates of reference points of the AOI and a radius of the AOI; coordinates of reference points of the AOI, a length of the AOI, and a width of the AOI; or at least one zone ID, indicating a geographic zone.

In some embodiments, the zone ID is preconfigured by the network device, or is determined based on the formula in section 5.10.13.2 of the 36.331 protocol in the 3GPP standard.

In some embodiments, the sensing request message is carried in at least one of a broadcast message, a paging message, RRC signaling, MAC CE signaling, or an NAS message.

In some embodiments, the network device is an access network device or a core network device. In the case that the network device is a core network device, an AMF transmits a sensing request message to the candidate terminal, or a sensing control network element SF transmits a sensing request message to the candidate terminal.

In S1020, the candidate terminal determines, based on the position information of the candidate terminal, whether to belong to the AOI.

In some embodiments, in response to receiving the sensing request message, the candidate terminal acquires position information of the geographic position of the candidate terminal.

In some embodiments, the position information of the candidate terminal is acquired by a GNSS or mobile communication positioning. In some embodiments, in the case that the position information of the candidate terminal is acquired by the mobile communication positioning, the mobile communication positioning is an NR positioning technology achieved by triggering signaling interaction between the base station and the terminal, or an SL positioning technology achieved by SL communication between the terminals, or other positioning technologies, which is not limited herein.

In some embodiments, measurement of the position information of the candidate terminal by the candidate terminal is triggered by receipt of the sensing request message. That is, in response to receiving the sensing request message, the candidate terminal measures the position of the candidate terminal by the GNSS function or the mobile communication positioning to acquire the position information. Alternatively, the candidate terminal automatically measures the position information of the candidate terminal based on a specific period. Upon receiving the sensing request message, the position information acquired in latest measurement or the latest valid position information is used.

In S1030, the candidate terminal transmits a feedback message to the network device.

In some embodiments, the candidate terminal performs validity detection on acquired position information. In the case that the position information of the candidate terminal is valid information, the candidate terminal transmits the feedback message to the network device based on the position information of the candidate terminal and the information of the AOI. In some embodiments, in the case that non-real-time measured position information acquired by the candidate terminal is valid information, the above position information is directly used in the process of transmitting the feedback message based on the position information and the AOI. That is, the measurement of the position information does not need to be triggered in real time.

In some embodiments, the feedback message from the candidate terminal to the network device is for indicating a matching result of the position information of the candidate terminal and the AOI. That is, the candidate terminal feeds back the matching result of the position information and the AOI to the network device, and the network device determines, based on the feedback message, whether the candidate terminal is in the AOI, and selects a device from candidate terminals in the AOI as the sensing node. Alternatively, the feedback message from the candidate terminal to the network device is for indicating whether the candidate terminal is capable of participating in the sensing measurement. That is, in the case that the candidate terminal is in the AOI, the candidate terminal transmits a feedback message indicating that the candidate terminal is capable of participating in the sensing measurement to the network device; and in the case that the candidate terminal is not in the AOI, the candidate terminal transmits a feedback message indicating that the candidate terminal does not participate in the sensing measurement to the network device, and the network device selects a device from candidate terminals as the sensing node based on whether the candidate terminal is capable of participating in the sensing measurement.

Illustratively, the candidate terminal transmits the feedback message to the network device based on the matching between the position information and the AOI. In some embodiments, the candidate terminal transmits different feedback messages to the network device based on different matching situations between the position information and the AOI. In the case that the position information of the candidate terminal belongs to the AOI, the candidate terminal transmits the first feedback message to the network device, and the first feedback message is for indicating that the candidate terminal participates in the sensing measurement. In the case that the position information of the candidate terminal does not belong to the AOI, the candidate terminal transmits the second feedback message to the network device, and the second feedback message is for indicating that the candidate terminal does not participate in the sensing measurement. That is, in determination of the feedback message from the candidate terminal, the network device determines that the candidate terminal participates in the sensing measurement in the case that the feedback message is the first feedback message, and the network device determines that the candidate terminal does not participate in the sensing measurement in the case that the feedback message is the second feedback message.

In some embodiments, the candidate terminal transmits the first feedback message to the network device only in the case that the position information is matched with the AOI. In the case that the position information of the candidate terminal belongs to the AOI, the candidate terminal transmits the feedback message to the network device. In the case that the position information of the candidate terminal does not belong to the AOI, the procedure is terminated. In the case that the network device receives the feedback message from the candidate terminal, the candidate terminal expects to participate in the sensing measurement. In the case that the network device does not receive the feedback message from the candidate terminal, the candidate terminal does not participate in the sensing measurement.

In some embodiments, the first device transmits the feedback message based on the matching of the position information of the first device and the AOI, and also based on whether the candidate terminal expects to participate in the sensing measurement.

In some embodiments, in the case that the position information of the candidate terminal belongs to the AOI, and configuration information of the candidate terminal is for indicating that the candidate terminal does not participate in the sensing measurement, the candidate terminal transmits the second feedback message to the network device. That is, in the case that the position of the candidate terminal is in the AOI, and the candidate terminal does not expect to be the sensing node, the candidate terminal transmits the second feedback message to the network device.

In some embodiments, in response to receiving the sensing request message, the candidate terminal first determines, based on the configuration information of the candidate terminal, whether the candidate terminal expects to participate in the sensing measurement. In the case that the configuration information of the candidate terminal is for indicating that the candidate terminal does not participate in the sensing measurement, the candidate terminal directly transmits the second feedback message to the network device, or, the candidate terminal does not transmit the feedback message to indicate that the candidate terminal does not participate in the sensing measurement. In the case that the configuration information of the candidate terminal is for indicating that the candidate terminal expects to participate in the sensing measurement, the feedback message is transmitted based on the position information of the candidate terminal and the AOI information in the sensing request message.

In some embodiments, the feedback message is carried in at least one of RRC signaling, MAC CE signaling, or an NAS message.

In some embodiments, the candidate terminal reports other measurement results to the network device in reporting the feedback message. That is, the candidate terminal reports measurement results to the network device, and the measurement results include at least one of a RSRP measurement result, an LOS probability, or an NLOS probability.

In some embodiments, in the case that the candidate terminal is in an idle state or an inactive state, the candidate terminal initiates random access to the network device based on a preconfigured random access channel (RACH) resource, and transmits the feedback message.

In some embodiments, in a case that the position information of the candidate terminal belongs to the AOI, the candidate device initiates random access to the network device based on the preconfigured RACH resource. The preconfigured RACH resource is for implicitly indicating that the position information of the candidate terminal belongs to the AOI. That is, for the candidate terminal in an idle state or an inactive state, in the case that the candidate terminal initiates random access based on the preconfigured RACH resource, the network device determines that the position information of the candidate terminal belongs to the AOI, such that quick indication of the candidate terminal in the AOI is achieved, the candidate terminal quickly enters a connection state to quickly respond to the sensing measurement.

In some embodiments, the preconfigured RACH resource is preconfigured by the network device to the candidate terminal by a RRC signaling.

In S1040, the network device determines the candidate terminal as the sensing node based on the feedback message.

Illustratively, in response to receiving the feedback message, the network device determines at least one candidate terminal from the candidate terminals as the sensing node.

In some embodiments, the network device determines the candidate terminal as the sensing node of which the feedback message is for indicating that the position information of the candidate terminal belongs to the AOI. In some embodiments, the network device determines the candidate terminal as the sensing node of which the feedback message is for indicating that the position information of the candidate terminal belongs to the AOI and configuration information is for indicating that the candidate terminal participates in the sensing measurement.

In some embodiments, upon determining that the position information of the candidate terminal belongs to the AOI, the network device screens out the candidate terminals again based on the RSRP measurement result, the LOS probability, and the NLOS probability that are reported by the candidate terminal.

In summary, in the method according to the embodiments, by providing the information of the AOI to the candidate terminal, the candidate terminal determines and feeds back whether to meet the condition to assist the network device in configuring an appropriate terminal as the sensing node, such that a problem that the network device cannot configure an appropriate UE for the AOI to perform the sensing operation due to unknown of the AOI of the sensing and distribution around the UE for the per-area sensing is addressed. Thus, the method improves the accuracy of determining the sensing node.

For the AOI, a target terminal selects the sensing node.

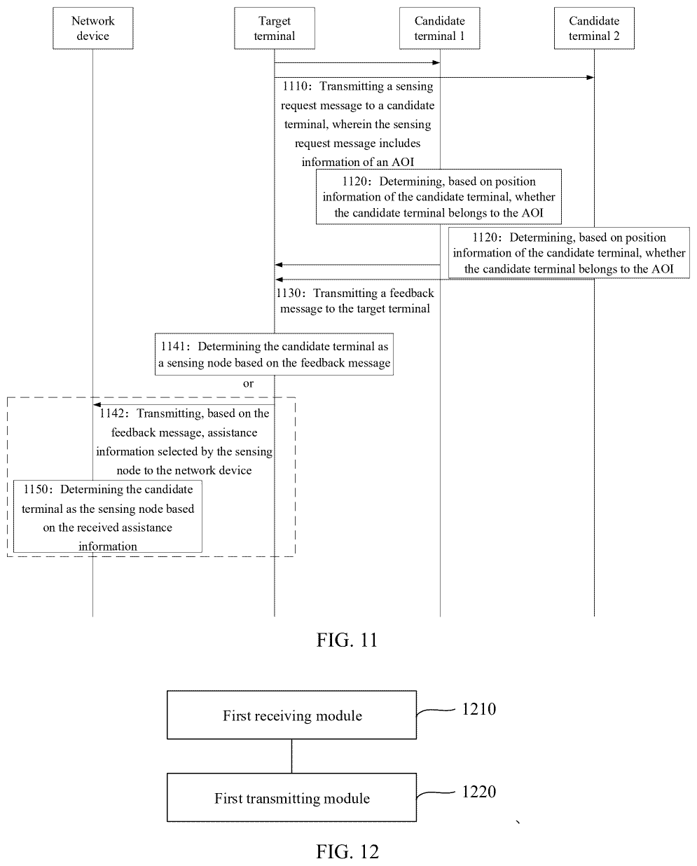

Referring to FIG. 11, a flowchart of a method for determining a sensing node according to some embodiments of the present disclosure is illustrated. In the embodiments, the first device is at least one candidate terminal, the second device is a target terminal, and the procedure of configuring the sensing node by the target terminal for the sensing measurement of the AOI in the per-area sensing is illustrated. The method includes following processes.

In S1110, a target terminal transmits a sensing request message to a candidate terminal, wherein the sensing request message includes information of an AOI.

The AOI is an area to be measured in sensing measurement. That is, the information of the AOI describes a geographic area, the area is an area required for the sensing measurement, and the target terminal expects to search for potential sensing nodes for the AOI.

In some embodiments, the geographic area indicated by the AOI may be an area defined at the granularity of a cell, a gNB, or a TA, or an area defined by a granularity smaller than any of the granularity of a cell, a gNB, or a TA.

In some embodiments, in the case that the granularity is smaller than the granularity of a cell, the target terminal cannot know position information of the candidate terminal, and thus the AOI needs to be indicated to the candidate terminal by the sensing request message in the sensing measurement, such that the candidate terminal gives feedback based on position information of the candidate terminal and the AOI to assist the target terminal in determining the sensing node.

In some embodiments, the information of the AOI includes at least one of: coordinates of reference points of the AOI and a radius of the AOI; coordinates of reference points of the AOI, a length of the AOI, and a width of the AOI; or at least one zone ID, indicating a geographic zone. In some embodiments, the zone ID is preconfigured by the target terminal, or is determined based on the formula in section 5.10.13.2 of the 36.331 protocol in the 3GPP standard.

In some embodiments, the sensing request message is carried in at least one of a broadcast message, RRC signaling, MAC CE signaling, or an NAS message.

In some embodiments, the sensing request message is transmitted over a PC5 interface between the candidate terminal (the first device) and the target terminal (the second device). That is, the message is transmitted between terminals by an SL communication technology.

In S1120, the candidate terminal determines, based on the position information of the candidate terminal, whether to belong to the AOI.

In some embodiments, in response to receiving the sensing request message, the candidate terminal acquires position information of the geographic position of the candidate terminal.

In some embodiments, the position information of the candidate terminal is acquired by a GNSS or mobile communication positioning. In some embodiments, in the case that the position information of the candidate terminal is acquired by the mobile communication positioning, the mobile communication positioning is an NR positioning technology achieved by triggering signaling interaction between the base station and the terminal, or an SL positioning technology achieved by SL communication between the terminals, or other positioning technologies, which is not limited herein.

In some embodiments, measurement of the position information of the candidate terminal by the candidate terminal is triggered by receipt of the sensing request message. That is, in response to receiving the sensing request message, the candidate terminal measures the position of the candidate terminal by the GNSS function or the mobile communication positioning to acquire the position information. Alternatively, the candidate terminal automatically measures the position information of the candidate terminal based on a specific period. Upon receiving the sensing request message, the position information acquired in latest measurement or the latest valid position information is used.

In S1130, the candidate terminal transmits a feedback message to the target terminal.

In some embodiments, the candidate terminal performs validity detection on acquired position information. In the case that the position information of the candidate terminal is valid information, the candidate terminal transmits the feedback message to the target terminal based on the position information of the candidate terminal and the information of the AOI. In some embodiments, in the case that non-real-time measured position information acquired by the candidate terminal is valid information, the above position information is directly used in the process of transmitting the feedback message based on the position information and the AOI. That is, the measurement of the position information does not need to be triggered in real time.

In some embodiments, the feedback message from the candidate terminal to the target terminal is for indicating a matching result of the position information of the candidate terminal and the AOI. That is, the candidate terminal feeds back the matching result of the position information and the AOI to the target terminal, and the target terminal determines, based on the feedback message, whether the candidate terminal is in the AOI, and selects a device from candidate terminals in the AOI as the sensing node. Alternatively, the feedback message from the candidate terminal to the target terminal is for indicating whether the candidate terminal is capable of participating in the sensing measurement. That is, in the case that the candidate terminal is in the AOI, the candidate terminal transmits a feedback message indicating that the candidate terminal is capable of participating in the sensing measurement to the target terminal; and in the case that the candidate terminal is not in the AOI, the candidate terminal transmits a feedback message indicating that the candidate terminal does not participate in the sensing measurement to the target terminal, and the target terminal selects a device from candidate terminals as the sensing node based on whether the candidate terminal is capable of participating in the sensing measurement.

Illustratively, the candidate terminal transmits the feedback message to the target terminal based on the matching between the position information and the AOI. In some embodiments, the candidate terminal transmits different feedback messages to the target terminal based on different matching situations between the position information and the AOI. In the case that the position information of the candidate terminal belongs to the AOI, the candidate terminal transmits a first feedback message to the target terminal, and the first feedback message is for indicating that the candidate terminal participates in the sensing measurement. In the case that the position information of the candidate terminal does not belong to the AOI, the candidate terminal transmits the second feedback message to the target terminal, and the second feedback message is for indicating that the candidate terminal does not participate in the sensing measurement. That is, in response to receiving the feedback message from the candidate terminal, the target terminal determines, in the case that the feedback message is the first feedback message, that the candidate terminal participates in the sensing measurement, and the target terminal determines, in the case that the feedback message is the second feedback message, that the candidate terminal does not participate in the sensing measurement.

In some embodiments, the candidate terminal transmits the first feedback message to the target terminal only in the case that the position information is matched with the AOI. In the case that the position information of the candidate terminal belongs to the AOI, the candidate terminal transmits the feedback message to the target terminal. In the case that the position information of the candidate terminal does not belong to the AOI, the procedure is terminated. In the case that the target terminal receives the feedback message from the candidate terminal, the candidate terminal expects to participate in the sensing measurement. In the case that the target terminal does not receive the feedback message from the candidate terminal, the candidate terminal does not participate in the sensing measurement.

In some embodiments, the first device transmits the feedback message based on the matching of the position information of the first device and the AOI, and also based on whether the candidate terminal expects to participate in the sensing measurement.

In some embodiments, in the case that the position information of the candidate terminal belongs to the AOI, and configuration information of the candidate terminal is for indicating that the candidate terminal does not participate in the sensing measurement, the candidate terminal transmits the second feedback message to the target terminal. That is, in the case that the position of the candidate terminal is in the AOI, and the candidate terminal does not expect to be the sensing node, the candidate terminal transmits the second feedback message to the target terminal.

In some embodiments, in response to receiving the sensing request message, the candidate terminal first determines, based on the configuration information of the candidate terminal, whether the candidate terminal expects to participate in the sensing measurement. In the case that the configuration information of the candidate terminal is for indicating that the candidate terminal does not participate in the sensing measurement, the candidate terminal directly transmits the second feedback message to the target terminal, or, the candidate terminal does not transmit the feedback message to indicate that the candidate terminal does not participate in the sensing measurement. In the case that the configuration information of the candidate terminal is for indicating that the candidate terminal expects to participate in the sensing measurement, the feedback message is transmitted based on the position information of the candidate terminal and the AOI information in the sensing request message.

In some embodiments, the feedback message is carried in at least one of RRC signaling, MAC CE signaling, or an NAS message.

In some embodiments, the feedback message is transmitted over a PC5 interface between the candidate terminal (the first device) and the target terminal (the second device). That is, the feedback message is transmitted over an SL communication specified signaling.

In S1141, the target terminal selects the candidate terminal as the sensing node based on the feedback message.

In some embodiments, the target terminal selects the sensing node based on the feedback message. Illustratively, the target terminal determines the candidate terminal as the sensing node of which the feedback message is for indicating that the position information of the candidate terminal belongs to the AOI. In some embodiments, the network device determines the candidate terminal as the sensing node of which the feedback message is for indicating that the position information of the candidate terminal belongs to the AOI and configuration information is for indicating that the candidate terminal participates in the sensing measurement.

In S1142, the target terminal transmits, based on the feedback message, assistance information selected by the sensing node to a network device.

In some embodiments, the target terminal selects an appropriate sensing node by the network device. That is, upon receiving the feedback message, the target terminal generates the assistance information based on the feedback message, and transmits the assistance information to the network device.

In some embodiments, the target terminal determines, based on the feedback message, the candidate terminal of which the position information belongs to the AOI, generates the assistance information of the candidate terminal of which the position information belongs to the AOI, and transmits the assistance information to the network device.

In S1150, the network device determines the candidate terminal as the sensing node based on the received assistance information.

In the case that position information of a plurality of first devices belongs to the AOI, the network device determines, based on the assistance information, at least one candidate terminal from the plurality of candidate terminals as the sensing node.

In summary, in the method according to the embodiments, by providing the information of the AOI to the candidate terminal, the candidate terminal determines and feeds back whether to meet the condition to assist the target terminal or the network device in configuring an appropriate terminal as the sensing node, such that a problem that the UE, the SF, or the AMF around the target UE cannot configure an appropriate secondary UE for the target UE to be the sensing node to perform the sensing operation due to unknown of distribution of other UEs is addressed. Thus, the method improves the accuracy of determining the sensing node.

FIG. 12 is a block diagram of an apparatus for determining a sensing node according to some embodiments of the present disclosure. The apparatus includes at least part of following modules:
a first receiving module 1210, configured to receive a sensing request message from a second device, the sensing request message including information of an AOI, wherein the AOI is an area to be measured in sensing measurement; and
a first transmitting module 1220, configured to transmit a feedback message to the second device based on position information of a first device and the information of the AOI, wherein:
the feedback message is for determining the sensing node participating in the sensing measurement.

In some embodiments, the information of the AOI includes at least one of: coordinates of reference points of the AOI and a radius of the AOI; coordinates of reference points of the AOI, a length of the AOI, and a width of the AOI; or at least one zone identifier, indicating a geographic zone.

In some embodiments, the information of the AOI is a first configuration condition in the sensing request message, and the sensing request message further includes a second configuration condition; wherein:
the second configuration condition includes at least one of an RSRP threshold, an LOS probability threshold, or an NLOS probability threshold.

In some embodiments, the feedback message includes condition matching results corresponding to various configuration conditions indicated by the sensing request message, or,
the feedback message includes a total condition matching result corresponding to all configuration conditions indicated by the sensing request message.

In some embodiments, the first transmitting module 1220 is further configured to report a measurement result to the second device, wherein the measurement result includes at least one of an RSRP measurement result, an LOS probability, or an NLOS probability.

In some embodiments, the sensing request message further includes at least one of an RSRP indication, an LOS indication, or an NLOS indication; wherein:

the RSRP indication is for instructing the first device to report the RSRP measurement result, the LOS indication is for instructing the first device to report the LOS probability, and the NLOS indication is for instructing the first device to report the NLOS probability.

In some embodiments, the measurement result is carried in the feedback message.

In some embodiments, the sensing request message is carried in at least one of a broadcast message, a paging message, RRC signaling, MAC CE signaling, or an NAS message.

In some embodiments, the sensing request message is transmitted over a PC5 interface between the first device and the second device.

In some embodiments, the first transmitting module 1220 is further configured to transmit a first feedback message to the second device in a case that the position information of the first device belongs to the AOI, wherein the first feedback message is for indicating that the first device participates in the sensing measurement.

In some embodiments, the first transmitting module 1220 is further configured to initiate random access to the second device based on a preconfigured RACH resource in a case that the position information of the first device belongs to the AOI, wherein:

the preconfigured RACH resource is for implicitly indicating that the position information of the first device belongs to the AOI.

In some embodiments, the first transmitting module 1220 is further configured to transmit a second feedback message to the second device in a case that the position information of the first device does not belong to the AOI, wherein the second feedback message is for indicating that the first device does not participate in the sensing measurement; or

the first transmitting module 1220 is further configured to transmit a second feedback message to the second device in a case that the position information of the first device belongs to the AOI and configuration information of the first device is for indicating that the first device does not participate in the sensing measurement.

In some embodiments, the position information of the first device is acquired by a GNSS or mobile communication positioning.

In some embodiments, the first transmitting module 1220 is further configured to transmit the feedback message to the second device based on the position information of the first device and the information of the AOI in a case that the position information of the first device is valid information.

In some embodiments, the feedback message is carried in at least one of RRC signaling, MAC CE signaling, or an NAS message.

In some embodiments, the feedback message is transmitted over a PC5 interface between the first device and the second device.

In some embodiments, the second device is at least one of a terminal device, an access network device, or a core network device.

In summary, in the apparatus according to the embodiments, based on the information of the AOI and the position information of the first device, the second device is assisted in determining the sensing nodes participating in the sensing measurement, and the solution for determining the sensing nodes is provided in the case that device distribution is unknown, such that the accuracy of determining the sensing node is improved.

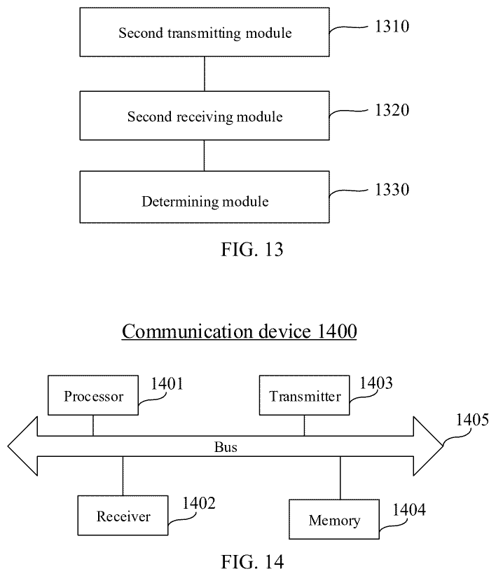

FIG. 13 is a block diagram of an apparatus for determining a sensing node according to some embodiments of the present disclosure. The apparatus includes at least part of following modules:
a second transmitting module 1310, configured to transmit a sensing request message to a first device, the sensing request message including information of an AOI, wherein the AOI is an area to be measured in sensing measurement;
a second receiving module 1320, configured to receive a feedback message from the first device; and
a determining module 1330, configured to determine, based on the feedback message, the sensing node participating in the sensing measurement.

In some embodiments, the information of the AOI includes at least one of: coordinates of reference points of the AOI and a radius of the AOI; coordinates of reference points of the AOI, a length of the AOI, and a width of the AOI; or at least one zone identifier, indicating a geographic zone.

In some embodiments, the information of the AOI is a first configuration condition in the sensing request message, and the sensing request message further includes a second configuration condition; wherein:
the second configuration condition includes at least one of an RSRP threshold, an LOS probability threshold, or an NLOS threshold.
In some embodiments, the feedback message includes condition matching results corresponding to various configuration conditions indicated by the sensing request message, or,
the feedback message includes a total condition matching result corresponding to all configuration conditions indicated by the sensing request message.

In some embodiments, the second receiving module 1320 is further configured to receive a measurement result from the first device, wherein the measurement result includes at least one of an RSRP measurement result, an LOS probability, or an NLOS probability.

In some embodiments, the sensing request message further includes at least one of an RSRP indication, an LOS indication, or an NLOS indication; wherein:
the RSRP indication is for instructing the first device to report the RSRP measurement result, the LOS indication is for instructing the first device to report the LOS probability, and the NLOS indication is for instructing the first device to report the NLOS probability.

In some embodiments, the measurement result is carried in the feedback message.

In some embodiments, the sensing request message is carried in at least one of a broadcast message, a paging message, RRC signaling, MAC CE signaling, or an NAS message.

In some embodiments, the sensing request message is transmitted over a PC5 interface between the first device and a second device.

In some embodiments, the second receiving module 1320 is further configured to receive a first feedback message from the first device, wherein the first feedback message is for indicating that the position information of the first device belongs to the AOI; and
the determining module 1330 is further configured to determine, based on the first feedback message, the first device as the sensing node participating in the sensing measurement.

In some embodiments, the second receiving module 1320 is further configured to receive random access initiated by the first device based on a preconfigured RACH resource, wherein the preconfigured RACH resource is for implicitly indicating that the position information of the first device belongs to the AOI; and
the determining module 1330 is further configured to determine, based on the random access, the first device as the sensing node participating in the sensing measurement.

In some embodiments, the second receiving module 1320 is further configured to receive a second feedback message from the first device, wherein the second feedback message is for indicating that the position information of the first device does not belong to the AOI, or is for indicating that the position information of the first device belongs to the AOI and configuration information of the first device is for indicating that the first device does not participate in the sensing measurement; and
the determining module 1330 is further configured to determine, based on the second feedback message, that the first device does not participate in the sensing measurement.

In some embodiments, the position information of the first device is acquired by a GNSS or mobile communication positioning.

In some embodiments, the feedback message is transmitted by the first device in a case that the position information of the first device is valid information.

In some embodiments, the feedback message is carried in at least one of signaling of an RRC signaling, a MAC CE signaling, or a NAS message.

In some embodiments, the feedback message is transmitted over a PC5 interface between the first device and a second device.

In some embodiments, a second device is at least one of a terminal device, an access network device, or a core network device.

In summary, in the apparatus according to the embodiments, based on the information of the AOI and the position information of the first device, the second device is assisted in determining the sensing nodes participating in the sensing measurement, and the solution for determining the sensing nodes is provided in the case that device distribution is unknown, such that the accuracy of determining the sensing node is improved.

FIG. 14 is a schematic structural diagram of a communication device (a terminal device or a network device) according to some embodiments of the present disclosure. The communication device 1400 includes: a processor 1401, a receiver 1402, a transmitter 1403, a memory 1404, and a bus 1405.

The processor 1401 includes one or more processing cores, and achieves various functional applications and information processing by running software programs and modules.

The receiver 1402 and the transmitter 1403 are practiced as a communication assembly. The communication assembly is a communication chip.

The memory 144 is connected to the processor 1401 over the bus 1405. The memory 1404 is configured to store one or more instructions, and the processor 1401, when loading and executing the one or more instructions, is caused to perform various processes in the above method embodiments.

In addition, the memory 1404 is practiced by any type of volatile or non-volatile storage device or combinations thereof. The volatile or non-volatile storage device includes but is not limited to a disk or optical disc, an electrically erasable programmable read only memory (EEPROM), an erasable programmable read-only memory (EPROM), a static random-access memory (SRAM), a read-only memory (ROM), a magnetic memory, a flash memory, or a programmable read-only memory (PROM).

Some embodiments of the present disclosure further provide a computer-readable storage medium storing one or more programs, wherein the one or more programs, when loaded and run by a processor, cause the processor to perform the method for determining the sensing node in the above method embodiments.

Some embodiments of the present disclosure further provide a chip. The chip includes programmable logic circuity and/or program instructions, wherein the chip, when running on a communication device, is caused to perform the method for determining the sensing node in the above method embodiments.

Some embodiments of the present disclosure further provide a computer program product. The computer program product, when running on a processor in a computer device, cause the computer device to perform the method for determining the sensing node in the above method embodiments.

Some embodiments of the present disclosure further provide a communication device. The communication device includes at least two of the above terminal devices, or a terminal device and a network device, and is configured to perform the method for determining the sensing node in the above method embodiments.

It should be understood by those skilled in the art that in the above one or more embodiments, functions described in the embodiments of the present disclosure are practiced by the hardware, the software, the firmware or any combinations thereof. In the case that the functions are practiced by the software, the functions are stored in the computer-readable storage medium or are determined as one or more instructions or codes in the computer-readable storage medium for transmission. The computer-readable storage medium includes a computer storage medium and a communication medium, and the communication medium includes any medium facilitating transmission of the computer program from one place to another place. The storage medium is any available medium accessible by a general or specific computer.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

1. A method for determining a sensing node, applicable to a first device, the method comprising:
receiving a sensing request message from a second device, the sensing request message comprising information of an area of interest (AOI), wherein the AOI is an area to be measured in sensing measurement; and
transmitting a feedback message to the second device based on position information of the first device and the information of the AOI, wherein the feedback message is for determining the sensing node participating in the sensing measurement.

2. The method according to claim 1, wherein the information of the AOI comprises at least one of:
coordinates of reference points of the AOI and a radius of the AOI;
coordinates of reference points of the AOI, a length of the AOI, and a width of the AOI; or
at least one zone identifier, indicating a geographic zone.

3. The method according to claim 1, wherein transmitting the feedback message to the second device based on the position information of the first device and the information of the AOI comprises:
transmitting a first feedback message to the second device in a case that the position information of the first device belongs to the AOI, wherein the first feedback message is for indicating that the first device participates in the sensing measurement.

4. The method according to claim 1, wherein transmitting the feedback message to the second device based on the position information of the first device and the information of the AOI comprises:
initiating random access to the second device based on a preconfigured random access channel (RACH) resource in a case that the position information of the first device belongs to the AOI, wherein the preconfigured RACH resource is for implicitly indicating that the position information of the first device belongs to the AOI.

5. The method according to claim 1, wherein transmitting the feedback message to the second device based on the position information of the first device and the information of the AOI comprises:
transmitting a second feedback message to the second device in a case that the position information of the first device does not belong to the AOI, wherein the second feedback message is for indicating that the first device does not participate in the sensing measurement.

6. The method according to claim 1, wherein the position information of the first device is acquired by a global navigation satellite system (GNSS) or mobile communication positioning.

7. The method according to claim 6, wherein transmitting the feedback message to the second device based on the position information of the first device and the information of the AOI comprises:
transmitting the feedback message to the second device based on the position information of the first device and the information of the AOI in a case that the position information of the first device is valid information.

8. A method for determining a sensing node, applicable to a second device, the method comprising:
transmitting a sensing request message to a first device, the sensing request message comprising information of an area of interest (AOI), wherein the AOI is an area to be measured in sensing measurement;
receiving a feedback message from the first device; and
determining, based on the feedback message, the sensing node participating in the sensing measurement.

9. The method according to claim 8, wherein the information of the AOI comprises at least one of:
coordinates of reference points of the AOI and a radius of the AOI;
coordinates of reference points of the AOI, a length of the AOI, and a width of the AOI; or
at least one zone identifier, indicating a geographic zone.

10. The method according to claim 8, wherein:
receiving the feedback message from the first device comprises:
receiving a first feedback message from the first device, wherein the first feedback message is for indicating that position information of the first device belongs to the AOI; and
determining, based on the feedback message, the sensing node participating in the sensing measurement comprises:
determining, based on the first feedback message, the first device as the sensing node participating in the sensing measurement.

11. The method according to claim 8, wherein:
receiving the feedback message from the first device comprises:
receiving random access initiated by the first device based on a preconfigured random access channel (RACH) resource, wherein the preconfigured RACH resource is for implicitly indicating that position information of the first device belongs to the AOI; and
determining, based on the feedback message, the sensing node participating in the sensing measurement comprises:
determining, based on the random access, the first device as the sensing node participating in the sensing measurement.

12. The method according to claim 8, wherein receiving the feedback message from the first device comprises:
receiving a second feedback message from the first device, wherein the second feedback message is for indicating that position information of the first device does not belong to the AOI; and
determining, based on the second feedback message, that the first device does not participate in the sensing measurement.

13. The method according to claim 8, wherein position information of the first device is acquired by a global navigation satellite system (GNSS) or mobile communication positioning.

14. The method according to claim 13, wherein the feedback message is transmitted by the first device in a case that the position information of the first device is valid information.

15. A terminal device, comprising: a processor, a transceiver connected to the processor, and a memory storing one or more executable instructions, which, when executed by the processor, the terminal device is configured to:
receive a sensing request message from a second device, the sensing request message comprising information of an area of interest (AOI), wherein the AOI is an area to be measured in sensing measurement; and
transmit a feedback message to the second device based on position information of a first device and the information of the AOI, wherein the feedback message is for determining a sensing node participating in the sensing measurement.

16. The terminal device according to claim 15, wherein the information of the AOI comprises at least one of:
coordinates of reference points of the AOI and a radius of the AOI;
coordinates of reference points of the AOI, a length of the AOI, and a width of the AOI; or
at least one zone identifier, indicating a geographic zone.

17. The terminal device according to claim 15, wherein the terminal device is further configured to:
transmit a first feedback message to the second device in a case that the position information of the first device belongs to the AOI, wherein the first feedback message is for indicating that the first device participates in the sensing measurement.

18. The terminal device according to claim 15, wherein the terminal device is further configured to:
initiate random access to the second device based on a preconfigured random access channel (RACH) resource in a case that the position information of the first device belongs to the AOI, wherein the preconfigured RACH resource is for implicitly indicating that the position information of the first device belongs to the AOI.

19. The terminal device according to claim 15, wherein the terminal device is further configured to:
transmit a second feedback message to the second device in a case that the position information of the first device does not belong to the AOI, wherein the second feedback message is for indicating that the first device does not participate in the sensing measurement.

20. The terminal device according to claim 15, wherein the position information of the first device is acquired by a global navigation satellite system (GNSS) or mobile communication positioning.
